(19) United States
(12) Patent Application Publication
(10) Pub. No.: US 2020/0269487 A1
(43) Pub. Date: Aug. 27, 2020

(54) SYSTEM AND METHOD FOR FORMING PARTS USING MOVEABLE HEATER AND RECOIL ALIGNMENT MECHANISM

(71) Applicant: Spirit AeroSystems, Inc., Wichita, KS (US)

(72) Inventor: Kerrick Robert Dando, Wichita, KS (US)

(73) Assignee: Spirit AeroSystems, Inc., Wichita, KS (US)

(21) Appl. No.: 16/282,487

(22) Filed: Feb. 22, 2019

(51) Int. Cl. B29C 51/26; B29C 51/08; B29C 51/38; B29C 51/42; B29C 51/00

(52) U.S. Cl. CPC B29C 51/262; B29C 51/082; B29C 51/004; B29C 51/425; B29C 51/38

(57) ABSTRACT

A system and method for forming a part using a moveable heater to heat a pre-aligned blank and an alignment mechanism to maintain the alignment of the heated blank during the forming process. A frame receives and holds the blank in the pre-aligned position within an open press. The heater advances into the press to heat the pre-aligned blank to a forming temperature, and withdraws to allow the press to close and form the heated blank into the part. The alignment mechanism maintains the blank in the alignment while the blank is heated and the press is closed, and includes a rail extending through the press and the frame and allowing the press to move between open and closed positions, and a collapsible member which pushes the frame as the press closes and collapses to allow the press to fully close and form the heated blank into the part.

### FIELD

The present invention relates to systems and methods for forming parts, and more particularly, embodiments concern a system and method for stamp- or mold-forming a blank of material into a part using a moveable heater to heat the blank in a pre-aligned position and a recoil alignment mechanism to maintain the alignment of the heated blank during the forming process.

### BACKGROUND

When stamp- or mold-forming parts, a blank of consolidated composite thermoplastic or other formable material is placed in a frame and restrained using spring clamps, the frame is transferred to an oven, and the blank is heated to its melt point to ensure the melting of the polymer matrix throughout the entire blank. The frame is then transferred to and aligned within a press and the part is formed under pressure to a desired shape by matched-mold tooling. The maximum allowable delay between removing the blank from the oven and forming the blank under pressure is five seconds or less before the blank rapidly cools to below its melt point. Thus, the blank must be removed from the oven, moved to the press, properly aligned within the press frame, and very quickly formed before the blank cools below the forming temperature (e.g., within five seconds for some materials). This is achievable for small parts (i.e., parts having dimensions of less than three feet) with uniform thicknesses, but has not been achievable for larger parts or parts with more complex geometries (e.g., buried ply drops). In particular, parts with increased size and/or complexity require complex part restraint and motion control systems in order to accomplish the move in time.

One problem arises with moving the large and/or complex part from the oven to the press both quickly and accurately. Spring clamps used in the frame to restrain the blank can cause misalignment and motion in the blank under high acceleration forces associated with the rapid transfer motion between processing steps. Another problem results from sagging or other flexing of the melted part as it is transferred from the oven to the press, which can change the alignment. Yet another problem occurs with the frame which holds the heated blank in place while a moving side of the press pushes the part the final distance and stamps it between dies under pressure without moving the frame. Misalignment and deformation can result when the moving die, which may be, for example, 400 degrees F., contacts the blank, which may be, for example, between 500 and 800 degrees F., and pushes the blank against the static die. This temperature difference and physical pushing can misalign the blank prior to or during actual forming. Furthermore, larger and/or more complex parts may experience uncontrolled deformation (e.g., stretching) during closure of the mold due to the static frame with springs having restrained lateral motion (i.e., the direction of the movement of the press), which prevents the heated blank from maintaining alignment with the tooling until it is fully formed under pressure. These issues outlined for the current production process create a potential (increasing with part size and complexity) for misalignment and premature cooling of the part prior to forming, which can adversely affect the dimensions of and introduce defects into the final part.

This background discussion is intended to provide information related to the present invention which is not necessarily prior art.

### SUMMARY

Embodiments of the present invention address the above-described and other problems and limitations in the prior art by providing a system and method for stamp- or mold-forming a blank of material into a part using a moveable heater to heat the blank in a pre-aligned position and a recoil alignment mechanism to maintain the alignment of the heated blank during press closure in the forming process.

In a first embodiment of the present invention, a system is provided for heating and aligning a blank of a material in order to form the blank into a part in a press including first and second dies. Broadly, the system may comprise a frame, a heater element, and an alignment mechanism. The frame may be holding the blank in an aligned position between the first and second dies. The heater element may be between a first position within the press to heat the blank in the aligned position to a forming temperature, and a second position to allow the first and second dies to form the blank into the part. The alignment mechanism may be maintaining the blank in the aligned positioned between the first and second dies as the first and second dies are brought together to form the blank into the part. The alignment mechanism may comprise a rail and a collapsible member. The rail may extend between the first and second dies and through the frame and allow the first die and the frame to slide between a first position in which the first and second dies and the frame are spaced apart and a second position in which the first and second dies and the frame are in physical contact. The collapsible member may extend between the first die and the frame and space the frame apart from the first die, push the frame toward the second die as the first die moves toward the second die, and collapse when the frame contacts the second die to allow the first and second dies to contact the blank and form the blank into the part.

In a second embodiment of the present invention, a method may be provided for heating and aligning a blank of a material in order to form the blank into a part in a press including first and second dies. Broadly, the method may comprise the following steps. The blank may be held in a frame in an aligned position between the first and second dies. A heater element may advance to a first position within the press to heat the blank in the aligned position to a forming temperature, and the heater element may withdraw to a second position to allow the first and second dies to form the blank into the part. The blank may be maintained in the aligned positioned between the first and second dies as the first and second dies are brought together to form the blank into the part. In more detail, the frame may be spaced apart from the first die using a collapsible member extending between the first die and the frame, wherein the first die and the frame are slidingly mounted on a rail extending between the first and second dies and through the frame. The first die may be moved along the rail toward the second die, wherein the collapsible member may push the frame along the rail toward the second die as the first die moves along the rail toward the second die. The collapsible member may collapse when the frame contacts the second die to allow the first and second dies to contact the blank and form the blank into the part.

Various implementations of the foregoing embodiments may include any one or more of the following features. The blank may have a dimension of at least five feet and/or an area of at least twenty-five square feet. The material may comprise a plurality of reinforcing fibers and a thermoplastic resin. The material may comprise a metal. The heater element using infrared or convection heating to heat the blank to the forming temperature. A first heater element may advance from a first direction and a second heater element may advance from a second direction to the first position, and the system may further comprise an indexing mechanism aligning the first and second heater elements at the first position. The collapsible member may comprise a spring and/or two or more nested elements. The system may further comprise a laser alignment system facilitating aligning the blank in the aligned position in the frame.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a high-level diagram of an embodiment of a system for forming a part, wherein the system is shown in an initial state with a blank received and held by a frame, a heater element withdrawn, and a press open;

FIG. 2 is a high-level diagram of the system of FIG. 1, wherein the system is shown with the frame holding the blank in an aligned position in the open press, and the heater element advanced and heating the blank to a forming temperature;

FIG. 3 is a high-level diagram of the system of FIG. 1, wherein the system is shown with the heater element withdrawn, and the frame holding the heated blank in the aligned position in the closed press to form the part;

FIG. 4 is a high-level diagram of the system of FIG. 1, wherein the system is shown at the final stage with the press open, and the frame holding the formed part which is ready to be unloaded;

FIG. 5 is a high-level diagram of a first embodiment of the system of FIG. 1 employing two heater elements;

FIG. 6 is a high-level diagram of a second embodiment the system of FIG. 1 employing one heater element; and

FIG. 7 is a flowchart of steps in an embodiment of a method for forming a part.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

Broadly characterized, embodiments of the present invention provide a system and method for stamp- or mold-forming a blank of material into a part using a moveable heater to heat the blank in a pre-aligned position and a recoil alignment mechanism to maintain the alignment of the heated blank during the forming process. More particularly, embodiments provide improvements in the field of large-scale stamp- or mold-forming large and/or complex parts of thermoplastic, metal, high-temperature composite, or other formable material by providing a moveable heater which heats the pre-aligned blank in situ in the press and a recoil alignment mechanism which maintains the alignment of the blank throughout the forming process. These improvements advantageously allow for more accurately, quickly, and repeatably forming larger and/or complex parts with fewer defects than is currently achievable using prior art technology.

Embodiments may include a moveable heater configured to advance to a first position, heat a blank of material which is already positioned and properly aligned within a press, and then quickly withdraw to a second position so that the press can close and the heated blank can be formed into the part. Broadly, in one implementation the heater may be configured to move (by, e.g., mechanical, hydraulic, or pneumatic force over a rail or other structure) into physical proximity with a blank which is already pre-aligned in the press, heat the blank to its melt or other forming temperature, and then quickly withdraw so that the heated blank can be formed under pressure between dies.

In more detail, the blank of (e.g., thermoplastic composite) material may be positioned within the press and properly aligned with the dies. Once the blank is properly aligned, one or more moveable heater elements may be advanced into position and activated to heat the blank positioned within the press to the desired temperature. Once the desired temperature has been reached, the one or more moveable heater elements may be withdrawn. Once the one or more moveable heater elements have been withdrawn, the press may be activated such that the dies are brought together on or around the heated blank to form the blank into the part before the blank cools below a minimum temperature.

This advantageously allows for pre-positioning and pre-aligning the blank prior to heating, which reduces or eliminates prior art problems arising from having to quickly transfer the heated blank and then quickly yet accurately align the transferred blank before it cools too much for forming, and also increases the overall efficiency of the process and allows for increased throughput. In particular, embodiments address problems and limitations in the prior art by providing more time to ensure an accurate alignment because the part is aligned prior to heating; the moveable heater can be withdrawn faster than a large part can be moved between a fixed oven and the press; and because the heater can be built into the press system, the need for a large track system for moving large blanks is reduced or eliminated. Additionally, the excess movement and misalignment caused by acceleration forces on the blank secured in the frame by spring clamps is negated through shifting the acceleration to the moving heater system.

Additionally or alternatively, embodiments may include a recoil alignment mechanism having a rail-mounted frame which receives the blank and accurately maintains the alignment of the blank throughout the forming process. Broadly, in one implementation a blank support frame may be mounted on a rail extending between the dies of the press, with one or more springs, nested elements, or other collapsible members extending between a moving portion of the press and the frame so as to transfer the movement of the moving portion of the press to the frame rather than directly to the blank during the forming process.

In more detail, the blank of (e.g., thermoplastic composite) material may be received and held by the frame and positioned within the press and properly aligned with the dies. The blank may be pre-heated in a fixed oven as in the prior art or heated in situ using the moveable heater elements described above. Regardless of how the blank is heated, once the blank has been heated and the heated blank is positioned and aligned within the press, the press may be activated such that the moving die pushes the frame toward the fixed die and the collapsible members collapse as the dies are brought together around the blank to form the blank into the part before the blank cools below a minimum temperature.

This advantageously allows for the frame with the pre-aligned blank to travel with the press as it closes, the collapsible members compress or otherwise collapse as the press closes, and the frame lands on the static die half and holds the aligned blank parallel to the dies until closure. In particular, embodiments address problems and limitations in the prior art by moving the frame with the press as it closes and by being mounted on collapsible members which collapse with the closure of the press to hold the blank to in the correct alignment until the press fully closes and the blank is formed under pressure. As the dies are moved together, the collapsible members contact the frame and compress as the blank is formed, and as the elements of the dies are moved apart, the collapsible members extend. Because the collapsible members maintain contact with the frame within which the blank is held, the blank is less likely to move out of alignment as the dies are moved together to form the blank. Further, misalignments and other problems due to temperature differences between the heated blank and the dies are reduced or eliminated by pushing against the frame rather than the blank and bringing the moving die into contact with the blank only once the frame is resting against the static die at the last moment when forming actually occurs.

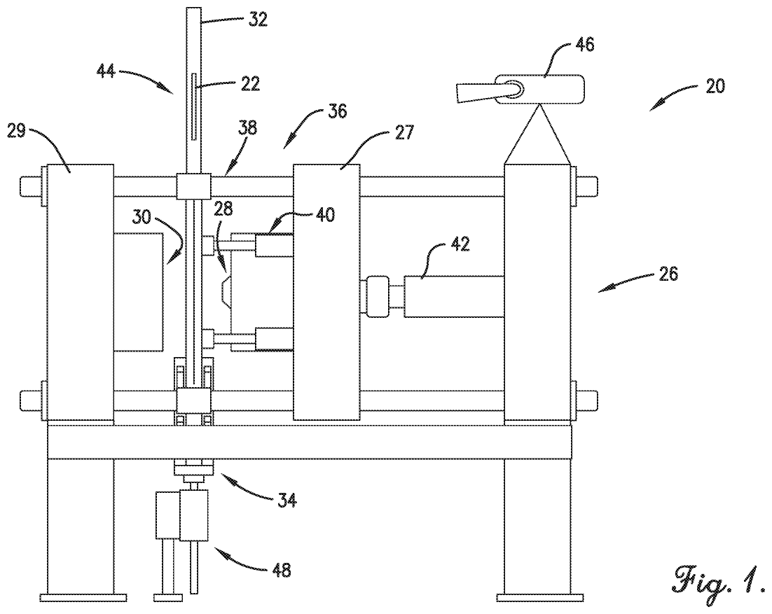

Referring to FIGS. 1-4, an embodiment of a system 20 is shown for heating and aligning a blank 22 of a material in order to form the blank 22 into a part 24 may include a press 26 having first and second dies 28,30, a frame 32, one or more heater elements 34, and an alignment mechanism 36 including one or more rails 38 and one or more collapsible members 40. The blank 22 may be constructed of substantially any suitable material which can be heated while in an initial shape, physically stamp- or mold-formed to have a different shape, and then cooled and retain the different shape. For example, the material may include a plurality of natural or synthetic fibers (e.g., fiberglass, Kevlar, carbon fiber) infused with a thermoplastic resin. For another example, the material may include a metal. The blank may be relatively large, such as having at least one dimension of at least five feet and/or an area of at least twenty-five square feet. Additionally or alternatively, the blank may be relatively complex, such as having multiple ply drops or thickness variations. In an example application, the resulting part 24 may be a component of a land, water, air, or space vehicle.

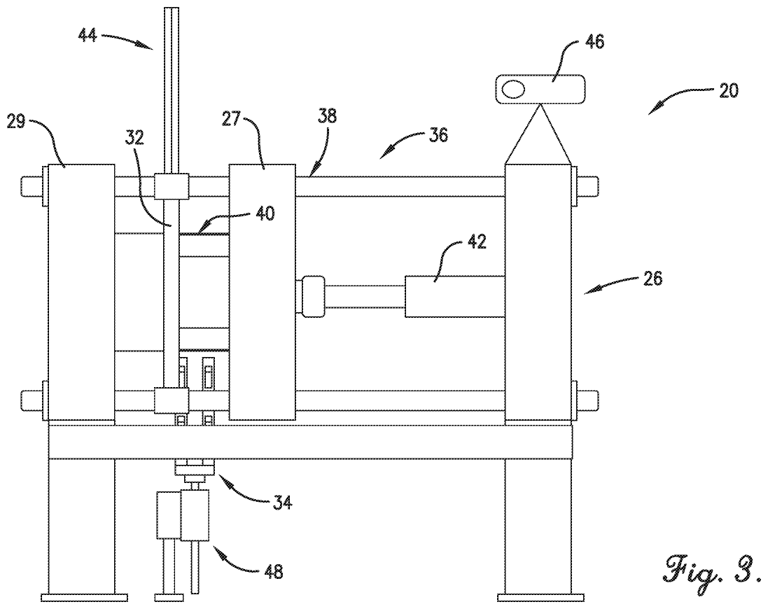

The press 26 may be configured to stamp- or mold-form the blank 22 once the blank 22 had been sufficiently heated and accurately aligned. The press 26 may employ substantially any suitable press technology for accomplishing this function. In one implementation, the press 22 may include a moveable press portion 27 including the first die 28, a corresponding static or fixed press portion 29 including the second die 30, and an actuation mechanism 42 configured to open and close the press 26. In more detail, the actuation mechanism 42 may be configured to move the moveable press portion 27 away from the fixed press portion 29 to receive the heated blank 22, as seen in FIG. 1, and to move the moveable press portion 27 toward the fixed press portion 29 to form the heated blank 22 between the first and second dies 28, 30 into the part 24, as seen in FIG. 3. The actuation mechanism 42 may employ substantially any suitable press mechanism technology, such as mechanical, electrical, pneumatic, or hydraulic technologies. It will be understood that the present technology can be adapted for differently designed presses, such as, for example, presses in which both press portions move.

The frame 32 may be configured to receive and hold the blank 22 in an aligned position between the first and second dies 28,30. In one implementation, the frame 32 may be mounted on a first positioning mechanism 44 configured to move the frame 32 to a first position which is not within the press 26 in order to receive the blank 22, as seen in FIG. 1, and then move the frame 32 holding the received blank 22 to a second position which is within the press 26 for forming, as seen in 2. A laser or similar alignment system 46 may be used to project an outline of the desired position of the blank 22 when the blank 22 is initially loaded into the frame 32, including indicating the locations of any ply drops or other internal complexities to increase alignment accuracy. As desired or needed, final alignment adjustments may be made once the frame 32 has reached the second position. After forming, the frame 32 may then return to the first position or move to a third position for unloading the part 24. In another implementation, the frame 32 may remain within the press 26 while the blank 22 is loaded and while the part 24 is unloaded.

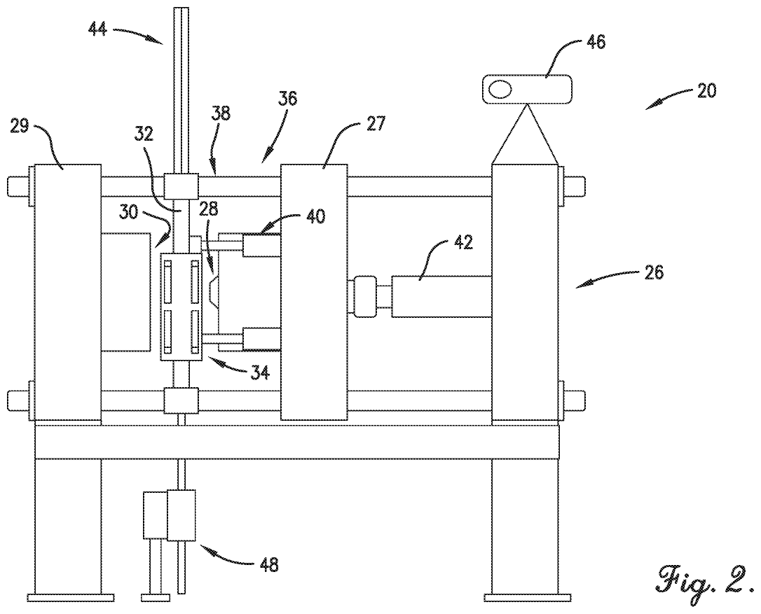

The heater elements 34 may be configured to advance to a first position within the open press 26 to heat the blank 22 in the aligned position to a melt or forming temperature, as seen in FIG. 2, and to withdraw to a second position to allow the first press 26 to close to form the heated blank 22 into the part 24, as seen in FIG. 3. The heater elements 34 may employ substantially any suitable heater technology, such as infrared, electric, or flame heating technologies. A movement mechanism 48 for moving the heater elements 34 may employ substantially any suitable movement mechanism technology, such as mechanical, electrical, pneumatic, or hydraulic technologies. In one implementation, the movement mechanism 48 may employ include one or more rails, channels, or similar structures on which the heater elements 34 roll, slide, or otherwise move between positions.

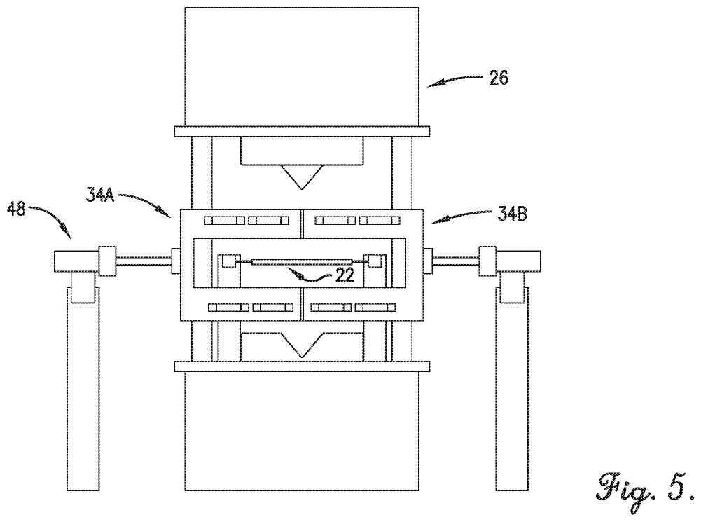

In a first embodiment, shown in FIG. 5, there may be first and second heater elements 34A, 34B which are split such that they can move apart to allow the blank 22 to be positioned in the open press 26, move together to heat the blank 22, and then move apart again to allow the press 26 to close and form the blank 22 into the part 24. The first and second heater elements 34A, 34B may employ an indexing mechanism, such as one or more pins or other projections on the first heater element 34A and a corresponding hole or other opening on the second heater element 34B, in order to ensure proper relative alignment and positioning when the heater elements 34A, 34B are brought together. In a related implementation, there may be three or more heaters which may operate in substantially the same way as the first implementation.

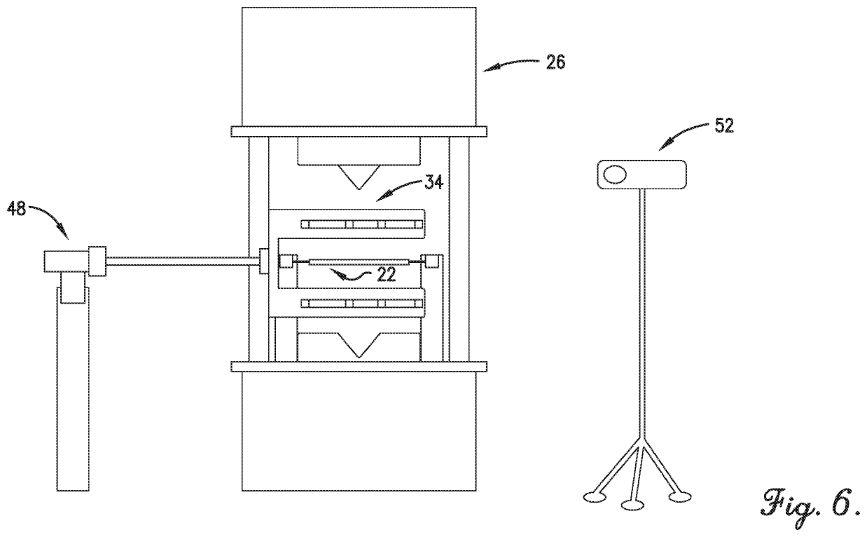

In a second embodiment, shown in FIG. 6, there may be a single heater element 34 which moves inward to heat the pre-positioned blank, and then moves outward to allow the press to close and form the blank into the part. In the third embodiment, the heater element 34 may cooperate with an indexing mechanism 52, such as a fixed alignment laser, in order to ensure proper positioning when the heater element 34 is moved in position.

The alignment mechanism 36 may be configured to maintain the blank 22 in the aligned positioned between the first and second dies 28, 30 as the press 26 is closed to form the blank 22 into the part 24. The rail component 38 of the alignment mechanism 36 may extend between the first and second portions of the press 26 and through the frame 32, and may be configured to allow the moveable portion of the press having the first die 28 and the frame 32 to slide between a first position in which the first and second dies 28, 30 and the frame 32 are spaced apart, as seen in FIG. 1, and a second position in which the first and second dies 28, 30 and the frame 32 are in physical contact, as seen in FIG. 3. The collapsible member component 40 of the alignment mechanism 36 may extend between the first moveable portion of the press 26 first die and the frame 32, and may be configured to space the frame 32 apart from the first die 28, as seen in FIG. 1, to push the frame 32 toward the second die 30 as the first die 28 moves toward the second die 30, and to collapse when the frame 32 contacts the second die 30, as seen in FIG. 3, to allow the first and second dies 28, 30 to contact the blank 22 and form the blank 22 into the part 24. The collapsible member 40 may employ substantially any suitable technology, such as spring or nested-element technologies. It will be understood that there may be a plurality of rail components 38 and/or collapsible members 40 (e.g., two to four or one for each corner of the frame 32 to minimize flexing), as desired or needed.

Implementations of the system 20 may further include an indexing or other alignment mechanism for aligning the first die 28, second die 30, frame 32, and/or blank 22 within the closing press. Example indexing or other alignment mechanisms include or may employ magnets, holes and corresponding pins, light emitting diodes and photodetectors, grommets in holes, strip clamps with holes in extensions, wire cables and beads, consolidated metal tabs coordinated to ply drops, and/or sacrificial material/shear edge holders.

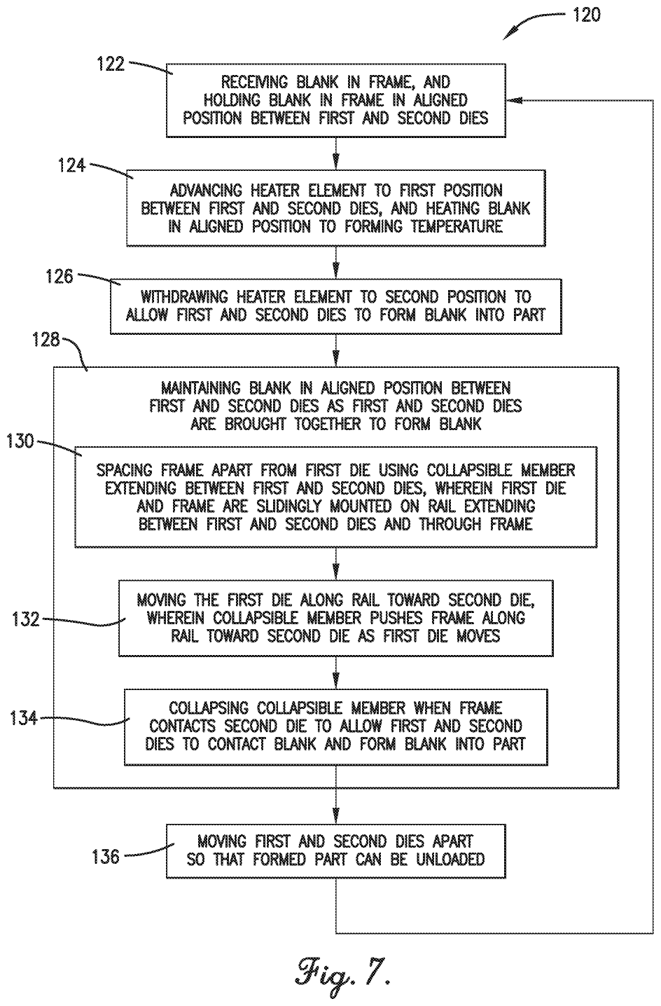

Referring also to FIG. 7, an embodiment of a method 120 is shown for heating and aligning a blank of a material in order to form the blank into a part. The method 120 may include the following steps. In one implementation, the method steps may reflect the operation of the system 20 described above, and may make use of or otherwise refer to some or all of the elements of that system 20. The blank 22 may be received by the frame 32, and held by the frame 32 in the aligned position between the first and second dies 28,30, as shown in 122 and seen in FIGS. 1 and 2. As discussed above, the frame 32 may receive the blank 22 in a first position which is not within the press 26, as seen in FIG. 1, and then the frame 32 holding the received blank 22 may move to a second position which is within the press 26, as seen in FIG. 2. Alternatively, the frame 32 may remain within the press 26 while the heated blank 22 is loaded and the formed part 24 is unloaded.

The heater element 34 may be advanced to a first position within the open press 26 (e.g., between the first and second dies 28,30) to heat the blank 22 held by the frame 32 in the aligned position to a forming temperature, as shown in 124 and seen in FIG. 2. The heater element 34 may then be withdrawn to a second position to allow the press 26 to close and the first and second dies 28, 30 to come together and form the blank 22 into the part 24, as shown in 126 and seen in FIG. 3.

The heated blank 22 may be maintained in the aligned positioned between the first and second dies 28, 30 as the first and second dies 28, 30 are brought together to form the blank 22 into the part 24, as shown in 128. In more detail, this may include the following substeps. The frame 32 may be spaced apart from the first die 28 by the collapsible member 40 extending between the first die 28 and the frame 32, wherein the first die 28 and the frame 32 are slidingly mounted on a rail 38 extending between the first and second dies 28, 30 and through the frame 32, as shown in 130 and seen in FIG. 2. The first die 28 may be moved along the rail 40 toward the second die 30, wherein the collapsible member 40 pushes the frame 32 along the rail 40 toward the second die 30 as the first die 28 moves along the rail 40 toward the second die 30, as shown in 132. The collapsible member 40 may collapse when the frame 32 contacts the second die 30 to allow the first and second dies 28, 30 to contact the blank 22 and form the blank 22 into the part 24, as shown in 134 and seen in FIG. 3.

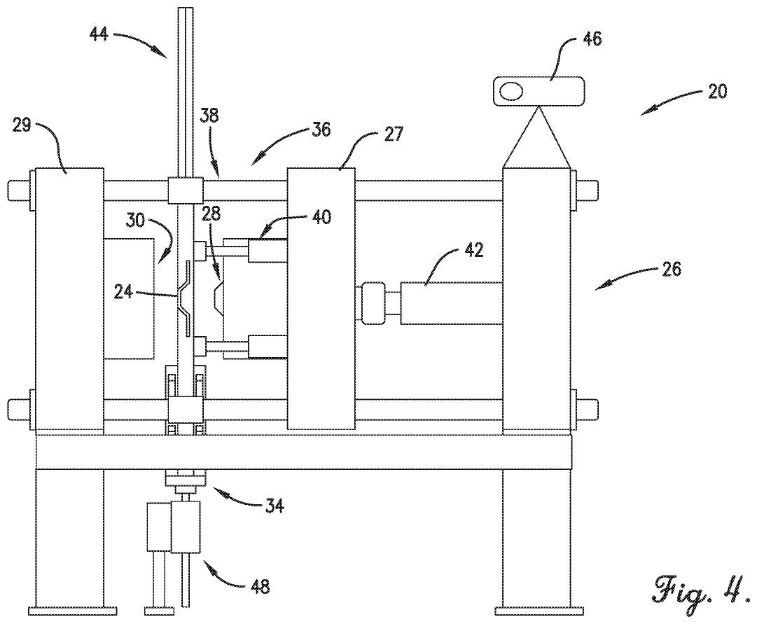

The first and second dies 28, 30 may then be moved apart so that the formed part 24 can be unloaded and the process can be repeated, as desired or needed, as shown in 136 and seen in FIG. 4. Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A system for heating and aligning a blank of a material in order to form the blank into a part in a press including first and second dies, the system comprising:
a frame holding the blank in an aligned position between the first and second dies;
a heater element moveable between a first position within the press to heat the blank in the aligned position to a forming temperature, and a second position to allow the first and second dies to form the blank into the part; and
an alignment mechanism maintaining the blank in the aligned positioned between the first and second dies as the first and second dies are brought together to form the blank into the part, the alignment mechanism comprising
a rail extending between the first and second dies and through the frame, the first die and the frame slidable between a first position in which the first and second dies and the frame are spaced apart, and a second position in which the first and second dies and the frame are in physical contact, and
a collapsible member extending between the first die and the frame, the collapsible member spaces the frame apart from the first die and pushes the frame toward the second die as the first die moves toward the second die, and collapses when the frame contacts the second die to allow the first and second dies to contact the blank and form the blank into the part.

2. The system of claim 1, wherein the blank has a dimension of at least five feet.

3. The system of claim 1, wherein the blank has an area of at least twenty-five square feet.

4. The system of claim 1, wherein the material comprises a plurality of fibers and a thermoplastic resin.

5. The system of claim 1, wherein the material comprises a metal.

6. The system of claim 1, wherein the heater element is an infrared heater.

7. The system of claim 1, wherein a first heater element advances to the first position from a first direction, and a second heater element advances to the first position from a second direction, and the system further comprises an indexing mechanism that aligns the first and second heater elements at the first position.

8. The system of claim 1, wherein the collapsible member comprises a spring.

9. The system of claim 1, wherein the collapsible member comprises two or more nested elements.

10. The system of claim 1, further comprising a laser alignment system that facilitates aligning the blank in the aligned position in the frame.

11. A system for heating and aligning a large blank of a material in order to form the large blank into a part in a press including first and second dies, wherein the material includes a plurality of fibers and a thermoplastic resin, the system comprising:
a frame holding the large blank in an aligned position between the first and second dies;
an infrared heater element movable between a first position within the press to heat the large blank in the aligned position to a melting temperature of the thermoplastic resin using infrared heating, and a second position outside the press, to allow the first and second dies to form the large blank into the part; and
an alignment mechanism which maintains the large blank in the aligned positioned between the first and second dies as the first and second dies are brought together to form the large blank into the part, the alignment mechanism comprising
a rail extending between the first and second dies and through the frame, the first die and the frame slidable on the rail between a first position in which the first and second dies and the frame are spaced apart, and a second position in which the first and second dies and the frame are in physical contact, and
a collapsible member extending between the first die and the frame and spacing the frame apart from the first die, the collapsible member pushes the frame toward the second die as the first die moves toward the second die, and then collapses when the frame contacts the second die to allow the first and second dies to contact the large blank and form the large blank into the part.

12. A method of heating and aligning a blank of a material in order to form the blank into a part in a press including first and second dies, the method comprising:
holding the blank in a frame in an aligned position between the first and second dies;
advancing a heater element to a first position within the press;
heating the blank in the aligned position to a forming temperature;
withdrawing the heater element to a second position to allow the first and second dies to form the blank into the part; and
maintaining the blank in the aligned positioned between the first and second dies as the first and second dies are brought together to form the blank into the part by
spacing the frame apart from the first die using a collapsible member extending between the first die and the frame, wherein the first die and the frame are slidingly mounted on a rail extending between the first and second dies and through the frame,
moving the first die along the rail toward the second die, wherein the collapsible member pushes the frame along the rail toward the second die as the first die moves along the rail toward the second die, and
collapsing the collapsible member when the frame contacts the second die to allow the first and second dies to contact the blank and form the blank into the part.

13. The method of claim 12, wherein the blank has a dimension of at least five feet.

14. The method of claim 12, wherein the blank has an area of at least twenty-five square feet.

15. The method of claim 12, wherein the material comprises a plurality of fibers and a thermoplastic resin.

16. The method of claim 12, wherein the material comprises a metal.

17. The method of claim 12, wherein the heater element uses infrared heating to heat the blank to the forming temperature.

18. The method of claim 12, wherein a first heater element advances from a first direction and a second heater element advances from a second direction to the first position, and the system further comprises an indexing mechanism that aligns the first and second heater elements at the first position.

19. The method of claim 12, wherein the collapsible member further comprises a spring.

20. The method of claim 12, wherein the collapsible member further comprises two or more nested elements.
